(19) United States
(12) Patent Application Publication
(10) Pub. No.: US 2024/0375565 A1
(43) Pub. Date: Nov. 14, 2024

(54) ACTIVE SUSPENSION SYSTEM FOR VEHICLE SEATS

(71) Applicant: GRAMMER Aktiengesellschaft, Ursensollen (DE)

(72) Inventor: Florian DOTZLER, Hirschau (DE)

(73) Assignee: GRAMMER Aktiengesellschaft, Ursensollen (DE)

(21) Appl. No.: 18/651,829

(22) Filed: May 1, 2024

(30) Foreign Application Priority Data
May 10, 2023 (DE) 10 2023 112 783.7

(51) Int. Cl. B60N 2/50; B60N 2/52

(52) U.S. Cl. CPC B60N 2/501; B60N 2/502; B60N 2/505; B60N 2/525

(57) ABSTRACT

The invention relates to an active vehicle seat suspension system with a lower part and an upper part of a vehicle seat and a scissor frame arranged therebetween with at least one first and at least one second scissor arm articulatedly connected thereto, wherein at least the first scissor arm is articulatedly connected with a first end to the upper part and is articulatedly connected with a second end to the lower part and is displaceable thereon, wherein at least one traction means which can move the second end of the first scissor arm forwards or backwards, as viewed in the longitudinal direction of the vehicle seat, is firmly connected to at least one rolling axle which is arranged at the second end.

### CROSS REFERENCE TO RELATED APPLICATION

This application claims the benefit of German Patent Application No. 10 2023 112 783.7, filed May 10, 2023, the entire contents of which are hereby incorporated herein by reference.

### FIELD

The invention relates to an active vehicle seat suspension system with a lower part and an upper part of a vehicle seat and a scissor frame arranged therebetween with at least one first scissor arm and at least one second scissor arm articulatedly connected thereto.

### BACKGROUND

Conventional vehicle seats with scissor frames between an upper and a lower part usually have a damper arranged between them, which serves to dampen the vibrations introduced from the outside and thus to dampen and absorb shocks to movement that are introduced into such a vehicle seat or such a vehicle suspension system, for example when driving through a pothole.

Such dampers or damping devices, possibly coupled with air suspension systems, are limited in their effect, however, as they have a finite stroke length and, depending on their current extension position, run the risk of coming into the system in a stroke end stop when an oscillation is initiated and are therefore no longer able to dampen the oscillation.

Frequently, such damper-air spring vehicle seat suspension systems also have the problem that the system overshoots when a vibration excitation is introduced into the vehicle seat suspension system from below, i.e. from the cab floor of a commercial vehicle such as a tractor, when driving over a pothole or driving over a bump. The result of such an overshoot is that although the damper can dampen the first introduced vibration or the vibration force, due to the presence of inertial forces in the vehicle seat suspension system, the system will swing out and overshoot in the opposite direction and the damper will reach its end stop. The relatively high spring rates on which such systems are based over the entire course of the oscillation also result in a certain natural frequency of the system.

### SUMMARY

Accordingly, the present invention is based on the task of providing an active vehicle seat suspension system which makes it possible to reduce overshoot movements of the system and possibly omit a damper element.

The core idea of the invention is that in an active vehicle seat suspension system with a lower part and an upper part of a vehicle seat and a scissor frame arranged therebetween with at least one first and at least one second scissor arm articulatedly connected thereto, wherein at least the first scissor arm is articulatedly connected with a first end to the upper part and is articulatedly connected with a second end to the lower part and is displaceable therein, at least one traction means, preferably in the form of a forwardly or rearwardly displaceable gear belt, is arranged at the second end of the first scissor arm, viewed in the longitudinal direction of the vehicle seat, and is firmly connected to at least one rolling axle arranged at the second end.

A timing chain, cable drive or any other type of chain drive or synchronised belt can also be used as a traction means.

If the movement of such a gear belt is driven by a motor and the gear belt is self-contained and has a constant length, it is possible for the gear belt to control the vibration of the vehicle seat suspension system without the aid of a damper element.

The motor, which acts and can act by means of its rotational movement force and its torque against a movement of the vehicle seat suspension system caused by a vibration introduced into the system, thus pulls the second end of at least one scissor arm forwards or backwards in a targeted manner in order to thereby adjust a change in the scissor arm position and thus a change in the height distance between the upper part and the lower part in a targeted manner and, if necessary, to brake it by means of the motor rotation. This means that when a swinging movement is initiated, for example from below or also when the vehicle seat is occupied by a driver from above, the movement of the scissor arm frame is damped in a targeted manner and the height distance between the upper part and the lower part is then readjusted by a counter-movement or counter-rotation of the motor.

The motor can be designed to rotate both anti-clockwise and clockwise for this purpose, and the gear belt is deflected on the motor. According to a preferred embodiment, the gear belt is connected to a motor arranged in front of the rolling axle in the longitudinal direction of the vehicle seat. Likewise, viewed in the longitudinal direction of the vehicle seat, the gear belt for this purpose is connected to at least one pulley behind the rolling axle and behind a gear belt connecting element, which is responsible for the fixed connection of the gear belt to the rolling axle, and is deflected thereon. Thus, the gear belt is advantageously and preferably self-contained and has a constant length. This gear belt is thus preferably deflected by means of the motor arranged at the front and the at least one rear pulley and can be moved in both running directions with the anti-clockwise- and clockwise-turning motor.

According to a preferred embodiment, both the pulley and the motor are stationarily attached to the lower part of the vehicle seat and thus of the vehicle seat suspension system, whereas the gear belt connecting element is firmly connected to the rolling axle, which can be rolled forwards and backwards or moved. For this purpose, according to a preferred embodiment, the rolling axle can be moved forwards or backwards by means of the gear belt within at least one guide rail of the lower part and thus pulled in order to change a height distance of the upper part in relation to the lower part.

The active and direct displacement of the axle within the guide rail of the lower part using the gear belt and the motor keeps the entire vehicle seat suspension system stable to a certain extent and reduces overshoot movements when vibration excitations are introduced into the system from below or above. No inertia force overcomes are necessary.

The spring rate of such active vehicle seat suspension systems can be almost zero, which means that almost no natural frequency of the system can occur.

In addition, such a clockwise and anti-clockwise rotating motor can adjust the gear belt as far as required, which means that the axle connected to it can be moved forwards or backwards as far as required, provided the guide rail is of a corresponding length. This means that-as with previous systems-there are no end stops for oscillation and suspension movements of the system. In addition, the motor can be energised in accordance with an initiated oscillation movement and thus a height movement of the vehicle seat, so that a braking effect of the height movement occurs by means of the motor and thus a cushioning of the initiated oscillation and the height movement of the vehicle seat takes place.

Advantageously, such a motor must overcome lower frictional forces due to the overall design. Such frictional forces have a maximum of 120 N. A damper is no longer necessary.

Such a gear belt should have no slip due to pre-tension and preferably has a constant length.

In order to measure the magnitude of a vibration introduced into the vehicle seat suspension system, the system preferably has an acceleration sensor device for measuring acceleration values of a vibrational movement introduced into the system from the outside.

In addition, according to a preferred embodiment, at least one height sensor device is arranged in the vehicle seat suspension system, which measures the height distance of the upper part in relation to the lower part.

The movement of the motor, also as a function of the measured height distance values and the measured acceleration values, is calculated, controlled and regulated by means of an arranged control device. When acceleration values of an oscillating movement introduced into the system are measured, the control device calculates and regulates a movement force opposite to the introduced oscillating movement by rotating the motor forwards and backwards and thus pulling the toothed wheel belt forwards or backwards on the rolling axle in order to bring the ends of the scissor arms together or apart. The scissor arm ends can be the two upper ends, which are arranged in the upper part of the vehicle seat, or the two lower ends, which are arranged in the lower part of the vehicle seat. According to a preferred embodiment, one of the ends of the two scissor arm ends is arranged on the upper part or the lower part by means of a fixed bearing and the second end of the other scissor arm is positioned on the upper part or the lower part in a displaceable or rollable manner by means of a floating bearing.

An air spring, which is arranged between the upper and lower parts and has a main volume, should be equipped with an additional volume of preferably 0.5-1.2 litres, particularly preferably 0.9 litres, which can be switched on or off. This has the advantage that in a force-displacement diagram, which reflects the spring characteristic of the vehicle seat suspension system, the characteristic has almost no gradient in its centre area over almost the entire width, which represents the height distance, i.e. it has a gradient of zero. The spring characteristic thus becomes so flat that an actuator, represented by the motor together with the gear belt, only has to apply or overcome a small additional frictional force, preferably of 50-200 N, particularly preferably of 100-120 N, for each height position of the vehicle seat. This is because the height position of the vehicle seat does not require any additional force due to the almost non-existent gradient of the spring characteristic. As a result, additional vibration damping of the entire vehicle seat suspension system can be achieved through a less complex counter-current or initiated counter-rotation or deceleration of the rotary movement of the motor.

Further advantages and preferred embodiments are shown in the sub-claims.

### BRIEF DESCRIPTION OF THE DRAWINGS

FIG. 1 a lateral cross-sectional view of a vehicle seat suspension system according to the invention with a vehicle seat in a first height position;

FIG. 2 a lateral cross-sectional view of the vehicle seat suspension system according to FIG. 1 in a second height position;

FIG. 3 a sectional view, a motor and a gear belt for driving the active vehicle seat suspension system according to the present invention and

FIG. 4 a spring characteristic curve of the vehicle seat suspension system according to the invention.

### DETAILED DESCRIPTION

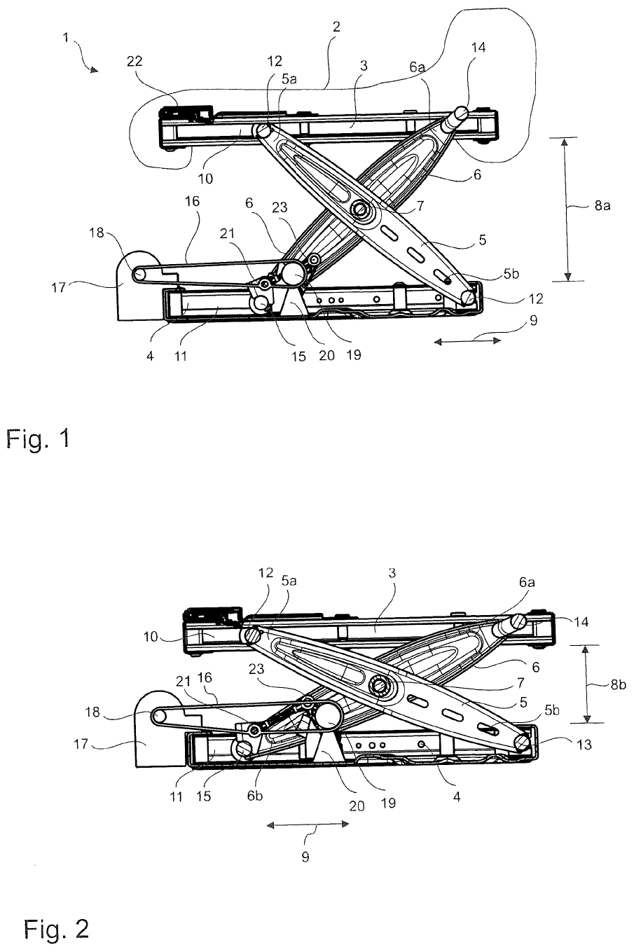

FIG. 1 shows a vehicle seat suspension system according to the invention in a first height position. The active vehicle seat suspension system has a vehicle seat 1, which comprises a seat cushion 2 on the upper side, which is only indicated.

The seat cushion 2 is arranged on an upper part 3, which is positioned so as to be vertically movable relative to a lower part 4 by means of scissor arms 5 and 6 arranged between them.

The scissor arms 5 and 6 are rotatably connected to each other by means of a joint connection 7, preferably arranged in the centre.

A first scissor arm 6 has an upper first end 6a and a lower second end 6b. The first end 6a is attached to the upper part 3 by means of a fixed joint connection 14. The second end 6b is arranged within a guide rail 11 of the lower part 4 by means of a displaceable or rollable floating bearing 15.

In the second scissor arm 5, the upper first end 5a is positioned as a displaceable floating bearing 12 within a guide rail 10 of the upper part 3. The lower second end 5b of the scissor arm 5 is articulatedly connected to the lower part 4 by means of a lower fixed bearing 13. The floating bearing arranged at the first end 5a has an axle 12.

The upper part is set relative to the lower part with a height distance 8a in a first position shown in this illustration.

The floating bearing with the rolling axle 15 arranged at the lower second end 6b of the first scissor arm 6 can be moved forwards and backwards within the guide rail 11 in accordance with the double arrow 9. The rolling axle 15 is connected to an essentially horizontal gear belt 16, which is self-contained and has a constant length. This gear belt 16 is deflected via a pulley 19, which is connected to the lower part in a fixed and stationary manner by means of a base 20, and a pulley 18, which is arranged on a motor. The motor 17 is also fixed and stationary relative to the lower part and can be connected to it.

If the gear belt 16 is now moved forwards and/or backwards by the motor 17 performing a clockwise or anti-clockwise rotation, a gear belt connecting element 21, which is firmly connected to the gear belt, is also moved forwards or backwards. This gear belt connecting element 21 is stationary and firmly connected to the rolling axle 15, so that when the gear belt connecting element 21 moves, the rolling axle 15 also moves.

Thus, due to the motor drive, a targeted movement of the rolling axle 15 either forwards or backwards is achieved by the motor rotating either anti-clockwise or clockwise. As long as the end stop is not reached within the guide rail 11, which is not undesirably premature due to the correspondingly long design of the guide rail, the lower ends 6b and 5b of the two scissor arms 6 and 5 are brought together or moved apart. As can be seen from a comparison of FIGS. 1 and 2, this results in a height adjustment of the upper part relative to the lower part. This can be recognised by comparing the two height distances 8a and 8b.

The height position of the vehicle seat suspension system shown in FIG. 2 is lower than the height position shown in FIG. 1. If, when an external oscillating movement is introduced into the vehicle seat suspension system from below, it is desired that the upper part 3 remains at the same height, although the lower part is moved upwards due to the introduced oscillating movement, this movement is accompanied by the gear belt 16 and the rotary movement of the motor 17 and is specifically braked by applying torque to the motor 17, thus cushioning the introduced oscillating movement. A subsequent upward swing of the upper part 3, after the lower part 4 can swing down again after passing over an elevation, can be prevented by specifically controlling the forward or backward displacement or rolling movement of the axle 15. In this way, no overshoot movement is obtained.

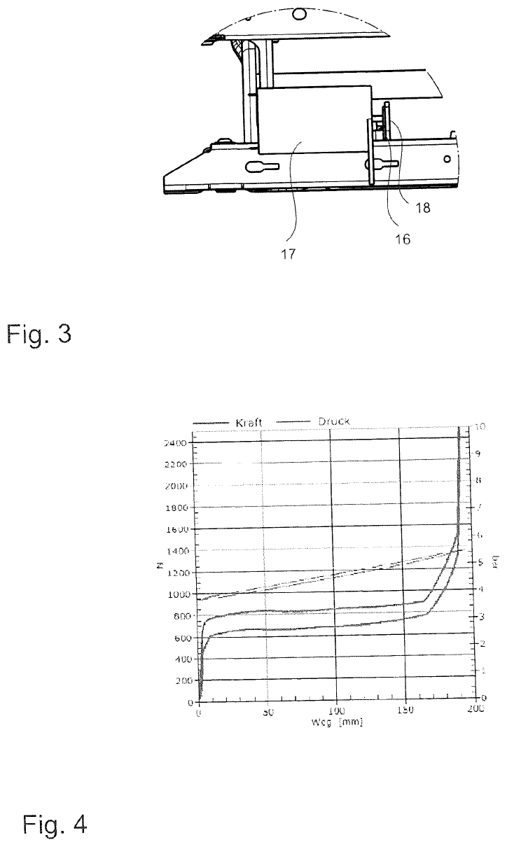

FIG. 3 shows a sectional view of the aforementioned motor 17 with the gear belt 16 and the pulley 18 in a front view. It can be seen from this illustration that the motor is fixed to the lower part 4 or fixed to a body floor.

The vehicle seat suspension system according to the invention has a control device 22 in order to specifically control the height movements or oscillation movements of the vehicle seat suspension system according to the invention described above and to control the motor with its clockwise or anti-clockwise rotation both in terms of speed and acceleration movement.

The control device comprises at least one acceleration sensor device for measuring acceleration values of a vibrational movement introduced into the system from outside. Such a vibrational movement can be both a vibrational movement introduced from below due to driving through a pothole or an elevation and a vibrational movement introduced from above due to a new occupancy of the vehicle seat by a driver.

An additionally arranged height sensor device 23 measures the height distance 8a, 8b of the upper part 3 in relation to the lower part 4.

The control device now calculates and controls the movement force, which is opposite to the initiated oscillating movement, by rotating the motor forwards and backwards and thus pulling the gear belt forwards or backwards on the axle, which is preferably a rolling axle, in order to move the scissor arm ends 5b, 6b together or apart when measuring acceleration values of an oscillating movement introduced into the system. This changes the height distance 8a, 8b between the upper part 3 and the lower part 4 and can be specifically controlled so that the upper part 3 remains at the same level in relation to the actual seat height of the driver.

FIG. 4 shows in a spring characteristic that in the presence of an air spring, which is not shown in the illustrations, together with an additional volume of, for example, 0.9 litres, the characteristic becomes so flat in the middle range that the motor 17 together with the gear belt 13 only has to overcome a frictional force of approx. 100-120 N at each height position of the upper part 3 in relation to the lower part 4. This low frictional force is overcome in order to achieve a damping effect of the entire suspension system in this range, but to achieve this without great effort within this range with a virtually non-existent gradient of the spring characteristic.

All features are regarded as advantageous and as preferred embodiments.

### LIST OF REFERENCE SIGNS

1 Vehicle seat

2 Seat cushion

3 Upper part

4 Lower part

5 Second scissor arm

5a Upper first end

5b Lower second end

6 First scissor arm

6a Upper first end

6b Lower second end

7 Joint connection

8a Height distance

8b Height distance

9 Longitudinal direction of the vehicle seat/double arrow

10 Guide rail

11 Guide rail

12 Floating bearing/axle

13 Lower fixed bearing

14 Fixed joint connection

15 Rolling axle/floating bearing

16 Gear belt; traction means

17 Motor

18 Pulley

19 Pulley

20 Base

21 Gear belt connecting element

22 Acceleration sensor device

23 Height sensor device

What is claimed is:

1. An active vehicle seat suspension system, comprising:
a lower part and an upper part of a vehicle seat; and
a scissor frame arranged therebetween with at least one first and at least one second scissor arm articulatedly connected thereto, wherein at least the first scissor arm is articulatedly connected with a first end to the upper part and is articulatedly connected with a second end to the lower part and is displaceable thereon,
wherein
at least one traction means which can move the second end of the first scissor arm forwards or backwards, as seen in the longitudinal direction of the vehicle seat, is firmly connected to at least one rolling axle which is arranged at the second end.

2. The vehicle seat suspension system according to claim 1, wherein the traction means, is driven in its movement by a motor.

3. The vehicle seat suspension system according to claim 1, wherein the traction means, is self-contained and has a constant length.

4. The vehicle seat suspension system according to claim 3, wherein the traction means is deflected as a gear belt, viewed in the longitudinal direction of the vehicle seat, in front of the rolling axle and in front of a gear belt connecting element on the motor and behind the gear belt connecting element with at least one pulley.

5. The vehicle seat suspension system according to claim 4, wherein the pulley and the motor are stationarily attached to the lower part.

6. The vehicle seat suspension system according to claim 3, wherein when the gear belt is driven by means of the motor, the rolling axle is moved forwards or backwards within at least one guide rail of the lower part in order to change a height distance of the upper part relative to the lower part.

7. The vehicle seat suspension system according to claim 1, further comprising:
at least one height sensor device which measures the height distance of the upper part relative to the lower part.

8. The vehicle seat suspension system according to claim 1, further comprising:
at least one acceleration sensor device for measuring acceleration values of a vibrational movement introduced into the system from the outside.

9. The vehicle seat suspension system according claim 1, further comprising;
a control device which, when measuring acceleration values of an oscillating movement introduced into the system, calculates and controls a movement force opposite to the introduced oscillating movement by forward or backward rotation of the motor and thus a forward or backward pulling of the gear belt on the rolling axle in order to bring the scissor arm ends together or apart.

10. The vehicle seat suspension system according to claim 1, wherein an air spring arranged between the upper and lower parts with a main volume and an additional volume which can be switched on or off.

11. The vehicle seat suspension system according to claim 2, wherein the traction means is a gear belt.

12. The vehicle seat suspension system according to claim 3, wherein the traction means is a gear belt.
